(19) United States
(12) Patent Application Publication
(10) Pub. No.: US 2017/0046092 A1
(43) Pub. Date: Feb. 16, 2017

(54) DATA DEDUPLICATION

(71) Applicant: HEWLETT PACKARD ENTERPRISE DEVELOPMENT LP, Houston, TX (US)

(72) Inventor: Sandya Srivilliputtur Mannarswamy, Bangalore (IN)

(21) Appl. No.: 15/305,304

(22) PCT Filed: Aug. 29, 2014
(86) PCT No.: PCT/US2014/053507

§ 371 Date: Oct. 19, 2016

(30) Foreign Application Priority Data
Jul. 4, 2014 (IN) 3319/CHE/2014

(51) Int. Cl. G06F 3/06

(52) U.S. Cl. CPC G06F 3/0641; G06F 3/0608; G06F 3/0659; G06F 3/0683; G06F 3/0619

(57) ABSTRACT

Some examples described herein relate to data deduplication. Redundancy information related to data may be recorded based upon a pre-defined rule. The redundancy information, which may be associated with the data, may be used during storage of the data in a storage system to determine that the data is redundant data of a previous data. An action related to the data may be performed.

### BACKGROUND

Organizations may need to deal with a vast amount of data these days, which could range from a few terabytes to multiple petabytes of data. Storage systems therefore have become central to an organization's IT strategy not withstanding whether it is a small start-up or a large company. Storage devices or systems (often used interchangeably) are no longer perceived as just a piece of hardware, but rather devices that help meet present and future information needs of an organization.

### BRIEF DESCRIPTION OF THE DRAWINGS

For a better understanding of the solution, embodiments will now be described, purely by way of example, with reference to the accompanying drawings, in which:

FIG. 1 is a block diagram of an example computing device for data deduplication;

FIG. 2 is a block diagram of an example system o data deduplication;

FIG. 3 is a flowchart of an example method for data deduplication; and

FIG. 4 is a block diagram of an example computer system for data deduplication,

### DETAILED DESCRIPTION

Increased adoption of technology by various businesses has led to an explosion of data. Enterprises are looking for efficient storage devices or systems to manage data growth and data storage costs. Many a time a storage system may contain duplicate or multiple copies of data. Minimizing the amount of data that needs to be stored in a storage system is one of the primary criteria for efficient storage systems. Eliminating redundant data not only helps in reducing storage hardware costs but also bandwidth costs whenever stored data needs to be transported over a network, for instance, for performing a backup or for meeting a compliance requirement.

Data deduplication is a technique for eliminating redundant data. Often, storage systems in an organization may contain duplicate copies of data. For example, a file (e.g., an email) may be saved in several different places by different users. Data deduplication reduces the amount of storage space required by an organization by eliminating such duplicate copies of files or blocks of data. In an example, data deduplication eliminates the additional copies, and saves just one copy of the data. The extra copies are replaced with pointers that lead back to the original copy,

However, most deduplication techniques typically rely on performing a binary level comparison between two sets of data in order to eliminate a duplicate copy. They do not consider the higher level semantic representation of data under comparison. For instance, two files may represent same content in different file formats, such as DOC, PPT, and PDF. Likewise, audio or video files having same content may also be stored in different file formats. Since present deduplication techniques are based on a comparison of only binary representation of data without taking into consideration any semantic aspects, they are unable to detect such “implicit redundancy” in data since at binary level the three files may have no redundancy that may be detectible by a deduplication technique or system. On the other hand, in another scenario, an application or user may like to keep duplicate copies of some data (e.g. a text document) for various reasons, such as backup or compliance. In this case, such redundancy may get detected by a deduplication system as a candidate for elimination, but the duplicate copy ideally should not be eliminated as the redundancy is desirable from the application or user's point of view. This may be termed as an “intended redundancy” situation. In both aforementioned scenarios, a deduplication system is unable to detect either an implicit or an intended redundancy prior to carrying out the deduplication of data.

To address these issues, the present disclosure describes various examples for performing data deduplication in a storage system. In an example, redundancy information related to data may be recorded based upon a pre-defined rule. Once recorded, the redundancy information may be associated with the data. The redundancy information associated with the data may be used, during storage of the data in a storage system, to determine that the data is redundant data of a previous data. Upon determination, an action related to the data may be performed. In an example, redundancy information related to data may be associated with provenance information of the data.

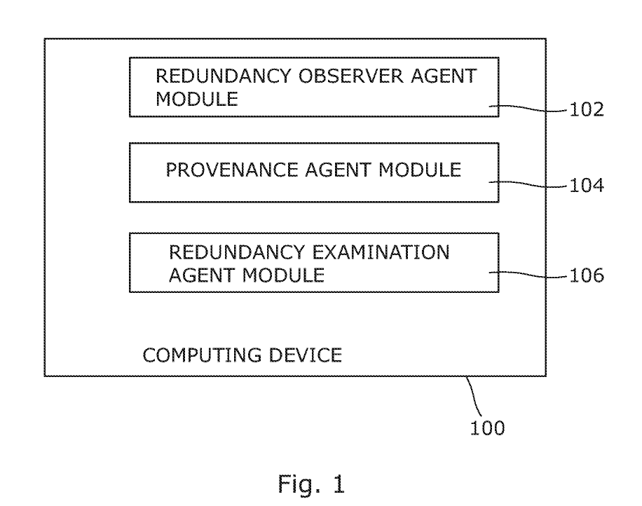

FIG. 1 is a block diagram of an example computing device 100 for facilitating data deduplication. Computing device 100 generally represents any type of computing system capable of reading machine-executable instructions. Examples of computing device may include, without limitation, a server, a desktop computer, a notebook computer, a tablet computer, a thin client, a mobile device, a personal digital assistant (PDA), a phablet, and the like.

In an example, computing device 100 may be a storage device or system. Computing device 100 may be a primary storage device such as, but not limited to, random access memory (RAM), read only memory (ROM), processor cache, or another type of dynamic storage device that may store information and machine-readable instructions that may be executed by a processor. For example, Synchronous DRAM (SDRAM), Double Data Rate (DDR), Rambus DRAM (RDRAM), Rambus RAM, etc. Computing device 100 may be a secondary storage device such as, but not limited to, a floppy disk, a hard disk, a CD-ROM, a DVD, a pen drive, a flash memory (e.g. USB flash drives or keys), a paper tape, an Iomega Zip drive, and the like. Computing device 100 may be a tertiary storage device such as, but not limited to, a tape library, an optical jukebox, and the like. In another example, computing device 100 may be a Direct Attached Storage (DAS) device, a Network Attached Storage (NAS) device, a tape drive, a magnetic tape drive, a data archival storage system, or a combination of these devices.

In an example, computing device 100 may be a data deduplication system. The term “data deduplication system”, as used herein, may refer to a system that reduces redundant data by storing only one unique instance of data on a storage device.

In the example of FIG. 1, computing device 100 may include a redundancy observer agent module 102, a provenance agent module 104, and a redundancy examination agent module 106. The term “module” may refer to a software component (machine readable instructions), a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. A module may reside on a volatile or non-volatile storage medium and configured to interact with a processor of computing device 100.

Redundancy observer agent module 102 may record redundancy information related to data based upon a pre-defined rule. In an example, redundancy observer agent module 102 may record redundancy information related to data when the data is created or modified. Redundancy observer agent module 102 may intercept a data creation or modification call and record redundancy information related to data if the pre-defined rule is satisfied. For instance, redundancy observer agent module 102 may record redundancy information for a file when the file is created or modified, for example, in a word processor application, a spreadsheet application, a presentation application, and the like. The redundancy information related to data may be recorded based upon a pre-defined rule. In other words, redundancy information related to data may be recorded if a pre-defined criterion related to data is fulfilled. In an instance, a pre-defined rule may include determining that the data is an alternative format of a previous data. In other words, redundancy information related to data may be recorded if it is determined that data under consideration i.e. data which is being created or modified is an alternative or additional format of an earlier data. To provide an example, redundancy observer agent module 102 may record redundancy information related to a PDF file, which is being created or modified, if it is determined that data in the PDF file is similar to data present in a previously stored file of another format, for instance, a DOC file, a PPT file, or any other file format. To provide another example, redundancy observer agent module 102 may record redundancy information related to a new TIFF file, if it is determined that data (e.g., an image) in the TIFF file is similar to data present in a previously stored file of another format, for instance, a JPEG file format, a PNG format, a GIF format, or any other image file format. The aforementioned rule is just an example of a pre-defined rule that may be used to determine whether the redundancy observer agent module 102 may record redundancy information related to data. There may be other example rules or criterion as well. If a pre-defined rule for data is fulfilled, the data may be identified as a candidate for logical redundancy elimination. In other words, the data may be considered for deletion from the system. Data transformations, such as the one described above, may be considered for creating candidates for logical redundancy elimination. Such data transformations may be defined in the form of rules into the redundancy observer agent module 102. For instance, one rule may be to consider only transformations that perform video format conversions from one format to another. Another rule may be to consider transformations involving text format conversions from one form to another for determining candidates for logical redundancy elimination.

Redundancy observer agent module 102 may record various aspects related to data as part of redundancy information. These may include, by way of non-limiting examples, source of data, source of an earlier or previous data, data conversion procedure for converting an earlier or previous data into data, data conversion procedure for converting data into previous data, signature of data, and signature of an earlier or previous data.

Redundancy observer agent module 102 may record redundancy information related to data based upon a pre-defined rule. In an example, redundancy observer agent module may record redundancy information related to data when the data is created or modified. For instance, redundancy observer agent module may record redundancy information upon creation or modification of a file.

In an example, redundancy observer agent module 102 may record redundancy information related to data in the form of a logical redundancy record. A logical redundancy record, thus, may include similar details related to data as described earlier in the context of redundancy information. Redundancy observer agent module 104 may associate or tag a logical redundancy record with data if the data meets the pre-defined rule. In an example, redundancy observer agent module 102 may associate or tag the same logical redundancy record with a previous format of data as well. Since same logical redundancy record may be tagged to data and its previous format, the information contained in the record may be used to regenerate the data from its previous format or vice versa.

Provenance agent module 104 may be used to associate the redundancy information related to data with the data. In an example, the redundancy information related to data may be recorded along with provenance information of the data. Provenance information of data, as used herein, may refer to lineage or ownership history of data. For instance, ownership history of data may include a description of how the data was created, when the data was created, who created the data, what application was used to create the data, where the data was stored, how often the data was modified, when was the last modification of data, and the like. The aforementioned are just some non-limiting examples of what may constitute provenance information related to data. Other details related to data may be included in the provenance information as well. In an example, provenance information may be metadata, which may be stored in a file system as file metadata or custom metadata. In an example, provenance information may be stored as extended file attributes of a file. Extended file attributes enable users to associate files with metadata not interpreted by the file system, whereas regular attributes have a purpose strictly defined by the file system. In an example, redundancy information related to data may be recorded along with provenance information of the data in the form of extended file attributes of a file. In another example, redundancy information related to data may be stored in an external database.

Redundancy examination agent module 106 may use the redundancy information related to data to determine whether the data is redundant data of a previous data. The aforesaid determination may be performed when the data is being stored in a storage device or system. Said differently, during storage of data, the redundancy examination agent module may use the logical redundancy record tagged with the data to determine whether the data is redundant data of a previous data. To provide an example, let's consider a case where a PDF file is being stored in a storage device or system. In this case, the redundancy examination agent module 106 may examine a logical redundancy record tagged with the PDF file to determine whether the data in the PDF file is redundant data of a previous data. In other words, whether same data is present in another file format such as DOC or PPT. In an example, the redundancy examination agent module 106 may use the recorded information to identify both the forward transformation, which transformed data in a previous format (i.e. a previous data) to the data under consideration (i.e. data under creation or modification), as well as the reverse transformation, which may transform the data under consideration (i.e. data under creation or modification) to data in an earlier format (i.e. a previous data).

If it is determined that the data is redundant data of a previous data, redundancy examination agent module 106 may perform an action related to the data. In an example, said action may include deleting the data or the previous data. In another example, said action may include regenerating the previous data from the data or vice versa. In a further example, said action may include retaining both the data as well as the previous data in the storage system.

In an example, upon determination that the data is redundant data of a previous data, redundancy examination agent module 106 may carry out a binary level data comparison between the data and the earlier data (i.e. data in another format) prior to performing an action related to the data. In case there's a binary level data match between the data and the earlier data, redundancy examination agent module 106 may perform any of the actions related to the data as described above.

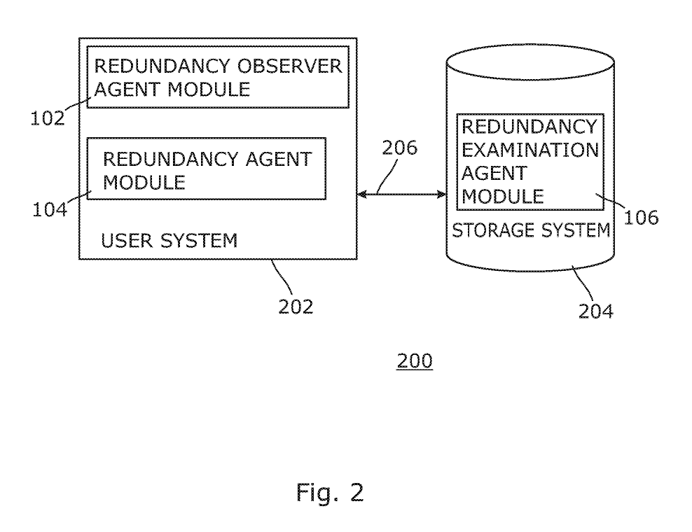

FIG. 2 is a block diagram of an example system for data deduplication. System 200 may include a user system 202, and a storage device or system 204. Although FIG. 2 shows only one user system and one storage device, other examples may include more user systems and storage devices.

User system 200 may be analogous to computing device 100, in which like reference numerals correspond to the same or similar, though perhaps not identical, components. For the sake of brevity, components or reference numerals of FIG. 2 having a same or similarly described function in FIG. 1 are not being described in connection with FIG. 2. Said components or reference numerals may be considered alike.

User system 202 may communicate with storage device 204 via a computer network, Computer network 206 may be a wireless or wired network. Computer network 206 may include, for example, a Local Area Network (LAN), a Wireless Local Area Network (WAN), a Metropolitan Area Network (MAN), a Storage Area Network (SAN), a Campus Area Network (CAN), or the like. Further, computer network 206 may be a public network (for example, the Internet) or a private network (for example, an intranet). In an example, user system 202 may be in direct communication with storage system 204.

User system 202 may include a redundancy observer agent module 102, and a provenance agent module 104. In an example, redundancy observer agent module 102 may record redundancy information related to data based upon a pre-defined rule, The redundancy information may be recorded along with provenance information of the data. Provenance agent module 104 may associate the redundancy information, recorded by the redundancy observer agent module, with the data. In an instance, the redundancy information related to data may be recorded as a logical redundancy record.

Storage device or system 204 may be used to store data or a previous format of the data. Storage device 204 may be a secondary storage device such as, but not limited to, a floppy disk, a hard disk, a CD-ROM, a DVD, a pen drive, a flash memory (e.g. USB flash drives or keys), a paper tape, an lomega Zip drive, and the like. Storage device 204 may be a tertiary storage device such as, but not limited to, a tape library, an optical jukebox, and the like. In some example, storage device 204 may include a Direct Attached Storage (DAS) device, a Network Attached Storage (NAS) device, a tape drive, a magnetic tape drive, or a combination of these devices.

an example, once the redundancy information is associated with data, the user system 202 may send the data to storage system 204 for storing the data. Storage system 204 may include a redundancy examination agent module 106 which may use the redundancy information related to data to determine whether the received data is redundant data of a previous data. The previous data may be present on the user system or the storage device. If it is determined that the data is redundant data of a previous data, redundancy examination agent module 106 may perform an action related to the data. In an example, said action may include deleting the data from the storage device. In another example, said action may include deleting the previous data from the user system or the storage device. In a yet another example, said action may include regenerating the previous data from the data or vice versa. In a further example, said action may include retaining both the data as well as the previous data in the user system and/or the storage system.

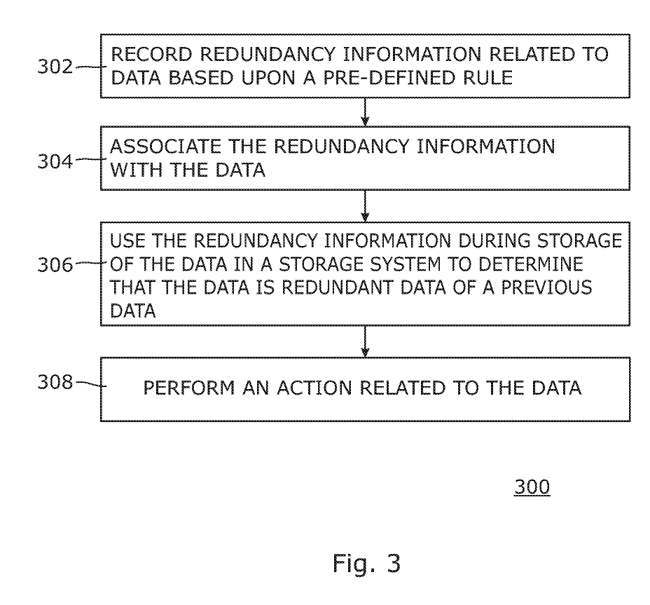

FIG. 3 is a flowchart of an example method 300 for data deduplication.

The method 300, which is described below, may at least partially be executed on a computing device 100 of FIG. 1 or on user system and storage system of FIG, 2. However, other computing devices may be used as well. At block 302, a redundancy observer agent module (example, 102) may record redundancy information related to data based upon a pre-defined rule. In other words, if a pre-defined rule related to data is fulfilled, the redundancy observer agent module (example, 102) may record redundancy information related to data. In an example, the redundancy observer agent module (example, 104) may record said redundancy information along with provenance information of the data. At block 304, a provenance agent module (example, 104) may associate the redundancy information recorded earlier with the data. In an example, the redundancy information may be associated with the provenance information of the data in the extended file attributes of a file system. At block 306, a redundancy examination agent module (example, 106) may use the redundancy information during storage of the data in a storage system to determine that the data is redundant data of a previous data. At block 308, redundancy examination agent module (example, 106) may perform an action related to the data. In an example, said action may include deleting the data from a storage device. In another example, said action may include deleting the previous data from a user system or a storage device. In a yet another example, said action may include regenerating the previous data from the data or vice versa. In a further example, said action may include retaining both the data as well as the previous data in a user system and/or a storage system.

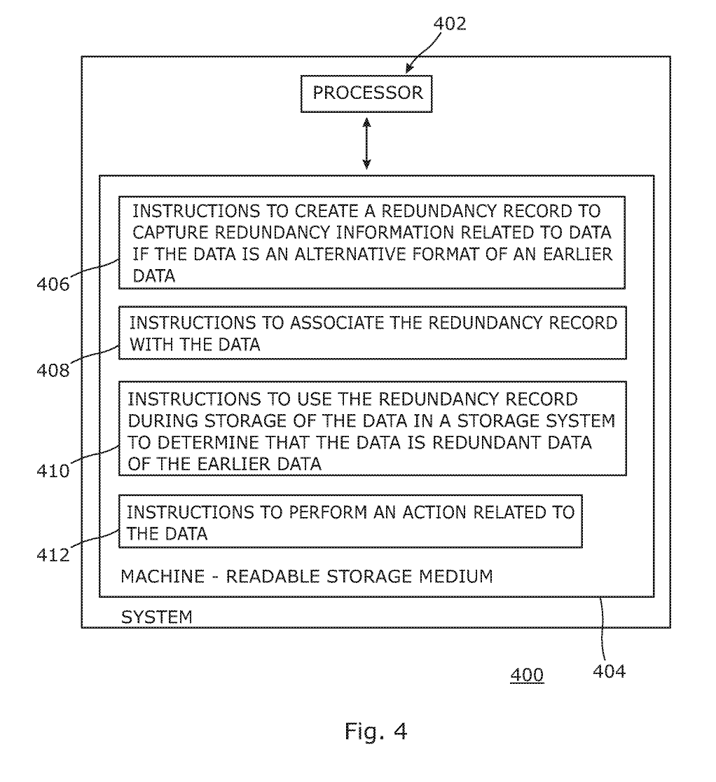

FIG. 4 is a block diagram of an example system 400 for data deduplication. System 400 includes a processor 402 and a machine-readable storage medium 404 communicatively coupled through a system bus. In an example, system 400 may be analogous to computing device 100 of FIG. 1 or user system and storage device of FIG. 2. Processor 402 may be any type of Central Processing Unit (CPU), microprocessor, or processing logic that interprets and executes machine-readable instructions stored in machine-readable storage medium 404. Machine-readable storage medium 404 may be a random access memory (RAM) or another type of dynamic storage device that may store information and machine-readable instructions that may be executed by processor 402. For example, machine-readable storage medium 404 may be Synchronous DRAM (SDRAM), Double Data Rate (DDR), Rambus DRAM (RDRAM), Rambus RAM, etc. or a storage memory media such as a floppy disk, a hard disk, a CD-ROM, a DVD, a pen drive, and the like. In an example, machine-readable storage medium 404 may be a non-transitory machine-readable medium. Machine-readable storage medium 404 may store instructions 406, 408, 410, and 412. In an example, instructions 406 may be executed by processor 402 to create a redundancy record to capture redundancy information related to data if the data is an alternative format of an earlier data. In example, said data may include a file or a chunk of a file. Instructions 408 may be executed by processor 402 to associate the redundancy record with the data. Instructions 410 may be executed by processor 402 to use the redundancy record during storage of the data in a storage system to determine that the data is redundant data of the earlier data. In an example, instructions 410 may further include instructions to perform a binary level data comparison between the data and the earlier data, Instructions 412 may be executed by processor 402 to perform an action related to the data. In an example, the action may include one of deleting the data, retaining the data, or regenerating the earlier data from the data. Machine-readable storage medium may further include instructions to associate the redundancy record with the earlier data, and use the redundancy record associated with the earlier data to regenerate the data from the earlier data,

For the purpose of simplicity of explanation, the example method of FIG. 3 is shown as executing serially, however it is to be understood and appreciated that the present and other examples are not limited by the illustrated order. The example systems of FIGS. 1, 2 and 4, and method of FIG. 3 may be implemented in the form of a computer program product including computer-executable instructions, such as program code, which may be run on any suitable computing device in conjunction with a suitable operating system (for example, Microsoft Windows, Linux, UNIX, and the like). Embodiments within the scope of the present solution may also include program products comprising non-transitory computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer. The computer readable instructions can also be accessed from memory and executed by a processor.

It may be noted that the above-described examples of the present solution is for the purpose of illustration only. Although the solution has been described in conjunction with a specific embodiment thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract and drawings), and/or all of the steps of any method or process so disclosed, may be combined in any combination, except combinations where at least some of such features and/or steps are mutually exclusive.

1. A method for data deduplication, comprising:
recording redundancy information related to data based upon a pre-defined rule;
associating the redundancy information with the data;
using the redundancy information during storage of the data in a storage system to determine that the data is redundant data of a previous data; and
performing an action related to the data,

2. The method of claim 1, wherein the redundancy information is associated with provenance information related to the data.

3. The method of claim 1, wherein the redundancy information is recorded during creation of the data.

4. The method of claim 1, wherein the action includes deleting the data or the previous data.

5. The method of claim 1, wherein the action includes regenerating the previous data from the data.

6. The method of claim 1, wherein the pre-defined rule includes determining that the data is an alternative format of the previous data.

7. A system for data deduplication, comprising:
a redundancy observer agent module to record redundancy information related to data based upon a pre-defined rule, wherein the redundancy information is recorded along with provenance information of the data;
a provenance agent module to associate the redundancy information with the data; and
a redundancy examination agent module to:
use the redundancy information during storage of the data to determine that the data is redundant data of a previously stored data: and delete the data.

8. The system of claim 7, wherein the data is stored in an external storage system.

9. The system of claim 7, wherein the redundancy information related to data is stored in an external database.

10. The storage of claim 7, wherein the redundancy information related to data is stored in extended file attributes.

11. A non-transitory machine-readable storage medium comprising instructions for data deduplication, the instructions executable by a processor to:
create a redundancy record to capture redundancy information related to data if the data is an alternative format of an earlier data;
associate the redundancy record with the data;
use the redundancy record during storage of the data in a storage system to determine that the data is redundant data of the earlier data; and
perform an action related to the data.

12. The storage medium of claim 11, wherein the action includes one of deleting the data, retaining the data, or regenerating the earlier data from the data.

13. The storage medium of claim 11, further comprising instructions to:
associate the redundancy record with the earlier data; and
use the redundancy record associated with the earlier data to regenerate the data from the earlier data.

14. The storage medium of claim 11, wherein the instructions to determine that the data is redundant data of the earlier data comprise instructions to:
perform a binary level data comparison between the data and the earlier data.

15. The storage medium of claim 11, wherein the data includes a file or a chunk of a file.
